(19) United States
(12) Patent Application Publication
(10) Pub. No.: US 2024/0204557 A1
(43) Pub. Date: Jun. 20, 2024

(54) Compact, Accurate, and Efficient Battery-Charging CMOS Voltage Regulator

(71) Applicant: Georgia Tech Research Corporation, Atlanta, GA (US)

(72) Inventors: Linyuan Cui, Atlanta, GA (US); Gabriel Alfonso Rincon-Mora, Atlanta, GA (US); Qian Zhi, Atlanta, GA (US)

(21) Appl. No.: 18/144,603

(22) Filed: May 8, 2023

Related U.S. Application Data
(60) Provisional application No. 63/433,901, filed on Dec. 20, 2022.

(51) Int. Cl. H02J 7/24

(52) U.S. Cl. CPC H02J 7/24; H02J 2207/20

(57) ABSTRACT

A battery-charging voltage regulator includes an inductor in series with a battery, an output terminal V_{O} selectively electrically connectable to the battery V_{B}; and an input terminal V_{IN} selectively electrically connectable to an input of the inductor L_{X}. The connections are such that the inductor always drains to the output. The device can include a battery supply mode, a charge supply mode, and an input-supplied mode depending on switching with the device, which in one aspect, can be implement in metal oxide semiconductors,

### CROSS REFERENCE TO RELATED APPLICATIONS

This application is a non-provisional of and claims priority benefit of U.S. Provisional Patent Application Ser. No. 63/433,901, filed Dec. 20, 2022, pending, which application is hereby incorporated by this reference in its entirety for all purposes as if fully set forth herein.

### BACKGROUND

### Field

Embodiments of the present invention relate to switched-inductor power supply systems, specifically a battery charging system in which a battery and a load are in series.

### Background

A battery-charging voltage regulator is a power supply system that can charge a battery and supply a load at the same time. Switched-inductor power supply systems deliver power with an inductor, transferring energy into and taking energy from the inductor by periodically energizing and draining it. An inductor energizes with a positive voltage across it, defined as a voltage that drops in the same direction as the current flow. It drains, then, with a negative voltage. Inductor current i_{L} ramps up and down with the voltage across it, signifying its energy transfer process, as shown in FIG. 1. FIG. 1 shows an inductor current waveform in continuous conduction mode (CCM).

Referring to FIG. 1, in CCM, the inductor current does not fall to zero during operation. In one switching period of a switched-inductor power supply, the inductor typically completes one energizing and one draining event. The energizing duty cycle d_{E} is therefore the time it takes to energize, t_{E}, over the entire switching period, t_{SW} [1].

$${d}_{E} = \frac{{t}_{E}}{{t}_{S W}} = \frac{{v}_{D}}{{v}_{E} + {v}_{D}} . \qquad ( 1 )$$

The draining duty cycle is then the complementary percentage. Δi_{L} in steady state operation, where the system repeats in the same way every cycle, is:

$$Δ {i}_{L} = ( \frac{{v}_{E}}{{L}_{X}} ) {t}_{E} = ( \frac{{v}_{D}}{{L}_{X}} ) {t}_{D} . \qquad ( 2 )$$

When a positive V_{E} can be established even when the output is directly connected to the inductor, usually when v_{O}<v_{IN}, the system is said to be operating in buck mode. The system is operating in boost mode when v_{O}>v_{IN}. Since the inductor cannot be energized into the output when in boost, the output only receives power during the draining duty cycle d_{D}, resulting in lower accuracy at the output as the output voltage ripples when the output capacitance is drained to supply power during d_{E}. The output duty cycle d_{O}, defined as the percentage of time where the output receives power, is d_{D} in this case.

For a system requiring a battery and an output to be supplied at the same time, a single input multiple output (SIMO) or multiple input multiple output (MIMO) solution with two inductors can be designed, where each inductor supplies one output [2, 3]. Even though such a multiple output system can provide for the battery and the load at the same time simultaneously, the downsides are increased space consumption and cost, as another bulky inductor is needed, as well as increased design overhead from needing more complex control loops. Using only one inductor is therefore desirable.

In current state of the art, single inductor DC-DC converter topologies effectively treat battery as a second output in parallel with the actual load [4-10]. The inductor energy is directed either to the load or the battery depending on the switching cycle or operating mode, but never both at the same time.

Defining output duty cycle of a simple one output converter, d_{O}, as the percentage of time the output is receiving power, d_{O} is 1 in buck converts and d_{D} in boost. The output duty cycle of a battery-charging voltage regulator, d_{O}′, may be defined as the percentage of time the output is receiving power instead of the battery. The output current i_{O} then can be expressed as:

$${i}_{o} = {i}_{L ( A V G )} {d}_{O} {d}_{O}^{′} , \qquad ( 3 )$$

which is highly duty-cycled.

This highly duty-cycled output results in poor dynamic accuracy, since the output needs to depend on the capacitor for power for entire, or at least heavily duty cycled, switching cycles, either creating big output voltage ripple or requiring a large output capacitance. The higher inductor current needed to be able to provide for the output in duty cycled bursts also greatly increases ohmic loss in the system.

In summary, there is a tradeoff between space/cost and accuracy/efficiency. A charging circuit according to principles described herein addresses these deficiencies of the state of the art.

### BRIEF SUMMARY OF THE DISCLOSURE

Accordingly, the present invention is directed to a compact battery-charging voltage regulator that obviates one or more of the problems due to limitations and disadvantages of the related art. Described herein is a new topology, arranging switches around a single inductor and a battery, such that the battery can be put in series with the load, allowing the battery to be charged with the load current while the load is being supplied simultaneously.

In accordance with the purpose(s) of this invention, as embodied and broadly described herein, this invention, in one aspect, relates to a battery-charging voltage regulator having an inductor L_{X}; a battery V_{B} in series with the inductor L_{X}; an output terminal VO selectively electrically connectable to the battery V_{B}; and an input terminal V_{IN} selectively electrically connectable to an input of the inductor L_{X}.

In another aspect, the invention relates to an inductor L_{X}; a battery V_{B} in series with the inductor L_{X}, wherein the inductor is between a first node V_{SWI} and a second node V_{SWX} and the battery is between the second node V_{SWX} and a third node V_{SWB}; an output terminal V_{O} selectively electrically connectable to the first node V_{SWI} via a first output switch S_{IO}, to the second node V_{SWX} via a second output switch S_{XO} and to the third node V_{SWB} via a third output switch S_{BO}; and an input terminal V_{IN} selectively electrically connectable to the first node V_{SW1} via an input switch S₁ between the first node VSW1 and the input terminal V_{IN}.

In a non-limiting aspect, any of the switches may be implemented in MOSFETs. For example, S_{XO} may be a N-Type MOSFET; S_{IO} may be a P-Type MOSFET; and S_{BO} may be a P-Type MOSFET. S_{I} may be a P-Type MOSFET with a first body connected to a with a first dynamic potential and the first output switch S_{IO} may be a P-Type MOSFET with a second body connected to a side with a second dynamic potential.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

Further embodiments, features, and advantages of the a compact battery-charging voltage regulator, as well as the structure and operation of the various embodiments of the a compact battery-charging voltage regulator, are described in detail below with reference to the accompanying drawings.

It is to be understood that both the foregoing general description and the following detailed description are exemplary and explanatory only, and are not restrictive of the invention as claimed.

### BRIEF DESCRIPTION OF THE DRAWINGS

The accompanying figures, which are incorporated herein and form part of the specification, illustrate a compact battery-charging voltage regulator. Together with the description, the figures further serve to explain the principles of the compact battery-charging voltage regulator described herein and thereby enable a person skilled in the pertinent art to make and use the compact battery-charging voltage regulator.

FIG. 1 shows an inductor current waveform in continuous conduction mode (CCM).

FIG. 2 illustrates a battery-charging regulator system.

FIG. 3 is a schematic of a system according to principles described herein.

FIG. 4 is a schematic of battery-supplied mode in simplified form.

FIG. 5 illustrates a charge-supply mode operation in simplified form.

FIG. 6 illustrates an alternative charge-supply mode operation in simplified form.

FIG. 7 is a schematic of Input-supplied mode operation in simplified form.

FIG. 8 illustrates one possible battery charging mode in simplified form.

FIG. 9 shows a possible fast charge mode in simplified schematic form.

FIG. 10 is a schematic showing a modified topology to allow battery assistance.

FIG. 11 shows a power stage according to principles described herein implemented in CMOS.

FIG. 12 shows V_{MAX} and V_{MIN} selector blocks according to principles described herein.

FIG. 13 is a schematic of a negative gate-driver supply MXO.

FIG. 14 illustrates optimization of PLoss.

FIG. 15 shows battery-supplied mode simulations of iL and vO.

FIG. 16 shows battery supplied mode simulation of vmin and vmax.

FIG. 17 shows charge-supply mode simulation of IL and VO.

FIG. 18 shows Charge-supply mode simulation vMIN and vMAX.

FIG. 19 shows Input-supplied mode simulation i_{L} and v_{O}.

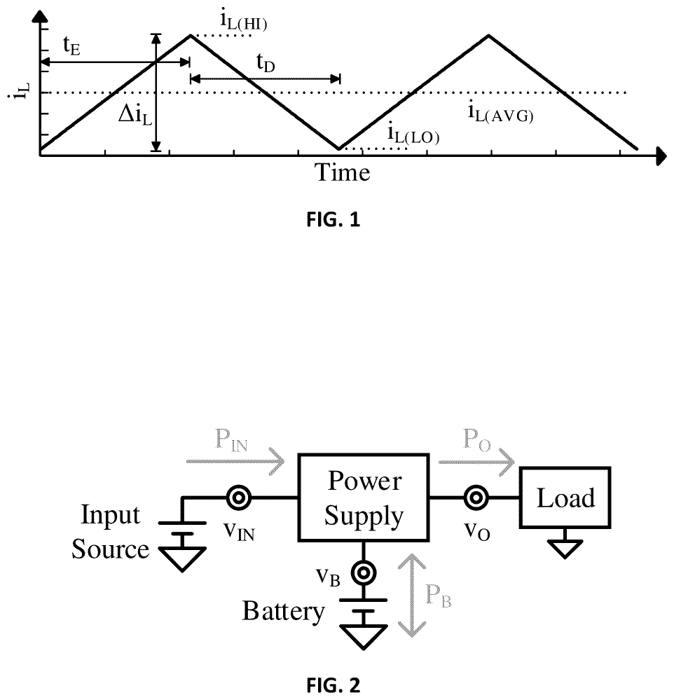

### DETAILED DESCRIPTION

Reference will now be made in detail to embodiments of the compact battery-charging voltage regulator with reference to the accompanying figures. The same reference numbers in different drawings may identify the same or similar elements.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

For applications that require an output and a battery to be supplied at the same time, there are generally two types of solutions. One solution is to utilize two inductors, which can power both loads simultaneously, but require extra space for two bulky inductors. The other solution is to use one single inductor to provide for the battery and load alternately, where the battery and the output can be considered to be in parallel. This solution has higher output ripple as the load is not being supplied when the battery is being charged, and has higher losses in the system from high duty-cycled inductor current.

In a world increasingly permeated by portable electronic devices, the demand for on-the-go charging, and battery to battery charging in general, is constantly rising. Therefore DC-DC converters that can charge batteries and at the same time provide for loads is an important topic for research.

Various circuit topologies described herein provide a new efficient battery-charging voltage regulator topology that mitigates the previously mentioned shortcomings, by allowing the battery and the load to be put in series, as a flying battery. This allows uninterrupted power output to the load while charging the battery at the same time, using only one inductor. An example system is described herein with reference to 5V input, which is a common voltage output from USB ports of laptops or power banks, and a 1.8V output voltage with output power up to 0.9 W, which is sufficient power for a lot of portable electronics. Although described herein with a 5V input/1.8V output, the topologies and various circuits can be implemented in various input/output values, as appropriate. In the 5V/1.8V example, the battery can be any lithium-ion battery with a 2.7-4.2V working voltage.

The fundamental battery-charging voltage regulator system needed for battery-to-battery charging can be described with the system level schematic above in FIG. 2. FIG. 2 illustrates a battery-charging regulator system. We have a load that constantly requires power when it's on, an input that can provide power but can be absent, and a battery that can provide power but needs to be recharged. The power supply system therefore needs to be able to regulate power between all I/O ports.

When the input is present, the system should be able to provide power to the load and charge the battery at the same time until the battery is full, at which point the system will switch to powering the output exclusively. When the input is absent, the system should be able to utilize the battery to power the load. By implementing such a system, the load can be supplied with or without the input being present.

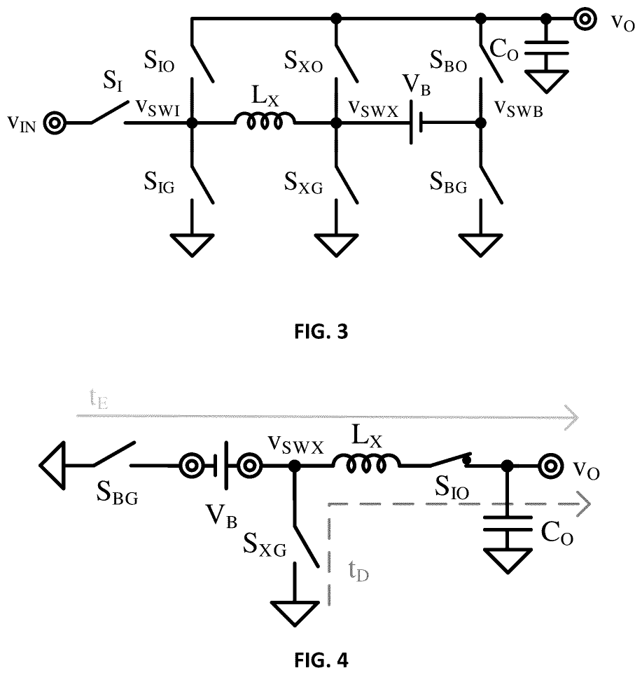

An ideal schematic for the proposed battery-charging voltage regulator is shown in FIG. 3. As illustrated, seven switches (SN) are arranged around one inductor (L_{X}) and a battery (V_{B}) to deliver power in all directions: input v_{IN} to output v_{O}, battery to output, and input to both battery and output. The v_{SWI} node connects to the input with a switch. The v_{SWX} node is a complex node that can connect to the battery V_{B}, the output v_{O}, or the battery V_{B} and the output v_{O} depending on the operating mode. The v_{SWB} node is the negative terminal of the battery.

In the proposed system, the battery V_{B} and output v_{O} can be put in series, which means they can always be powered at the same time. Furthermore, for this system, all the operating modes are designed so that the load is always supplied across an energizing duty cycle d_{E} and draining duty cycle d_{D}, and never depends on an output capacitance Co for power, except for during load dump events. This results in high dynamic accuracy. Since the output is always connected to the inductor L_{X}, the inductor current it is the load current i_{O}, as shown in (4), instead of a much-higher-than-i_{O} current due to the duty cycle shown in (3).

$${i}_{o} = {i}_{L ( A V G )} {d}_{O} {d}_{O}^{′} = {i}_{L ( A V G )} . \qquad ( 4 )$$

Therefore, the ohmic loss in the system, which has a square relationship with the inductor current i_{L}, is greatly reduced.

This topology also eliminates the switch usually put in front of the positive terminal of the battery to isolate it, by utilizing a floating battery. Therefore, all associated power loss such as ohmic loss, gate charging loss, etc. are reduced. The proposed topology would also have a simplified control scheme, since instead of regulating both the battery current and output voltage, the controller can now simply regulate the output voltage while the battery is automatically charged with the load current. A possible drawback of this topology is reduced output application flexibility, due to the need for the output current and battery current to match in a series configuration.

In the present example for the intended application, the system is supplied by a 5V USB input, since power banks and laptop usually provide power through USB ports [11]. The system should be able to provide up to 500 mA to a 1.8V output, which is a reasonable power draw to expect from USB[12]. The battery is selected as a lithium-ion battery, its voltage typically ranges from 2.7V to 4.2V. The resulting system has 3 operating modes. For now, only continuous conduction mode (CCM) is discussed.

### Battery-Supplied Mode

The system is in battery-supplied mode if the input is absent, and the battery supplies the output. The simplified schematic for this mode is shown in FIG. 4. FIG. 4 is a schematic of battery-supplied mode in simplified form. The power stage is configured into a buck converter, where S_{BG} is the energize switch and S_{XG} is the drain switch. S_{IO} is always on in this mode to continuously supply power to the output from the inductor. The energizing voltage v_{E} is therefore (v_{B}-v_{O}), and the draining voltage is v_{O}. The ideal energizing duty cycle in this mode where we deliver power from battery to output can be expressed as

$${d}_{E B O} = \frac{{v}_{O}}{{v}_{B}} + \frac{{v}_{D X G}}{{v}_{B}} ( \frac{2 {t}_{D T}}{{t}_{C}} ) , \qquad ( 5 )$$

where v_{DXG} is the voltage dropped across S_{XG}'s body diode, or, if lower, the threshold voltage of S_{XG}. t_{DT} is the dead-time defined as 5 ns for simulation purposes, and t_{C} is the conduction time that is equal to switching period t_{SW} in continuous conduction mode.

### Charge-Supply Mode

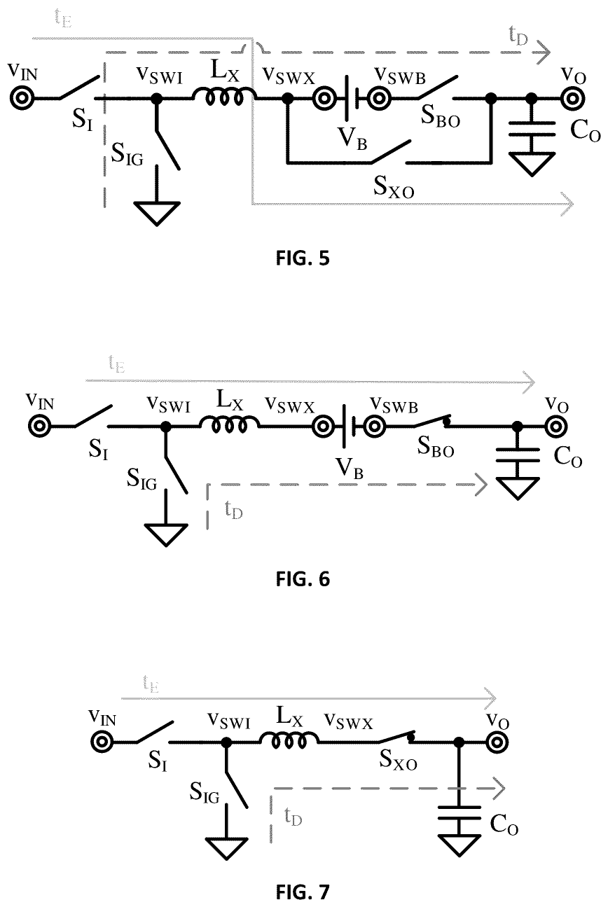

Charge-supply mode is entered when input is present and battery is not full, and it is possible to provide power to both the battery V_{B} and the output v_{O} simultaneously. The simplified schematic for this mode is shown in FIG. 5. Battery V_{B} and the output v_{O} may be put in series to provide power to both the battery V_{B} and the output v_{O}, but the resulting series voltage on v_{SWX} node (v_{O}+V_{B}) exceeds the range that the input voltage v_{IN} can be reliably bucked to. Therefore, the power stage is configured as a modified buck-boost.

S_{I} and S_{XO} are on during the energizing duty cycle, and SIG and S_{BO} are on during the draining duty cycle. The inductor is energized with (v_{IN}-v_{O}), where power is delivered to the output, and drained with (v_{O}+v_{B}), where power is delivered to both battery and output. The dead-time current is also carefully directed to the output. Therefore in this mode the output duty cycle d_{O} is still 100%. The ideal energizing duty cycle in this mode where we deliver power from input to battery and output can be expressed as

$${d}_{EIBO} = \frac{{v}_{B} + {v}_{O}}{{v}_{I} + {v}_{B}} + \frac{{v}_{D I G} + {v}_{D B O}}{{v}_{I} + {v}_{B}} ( \frac{2 {t}_{D T}}{{t}_{C}} ) , \qquad ( 6 )$$

where v_{DBO} is the voltage dropped across S_{BO}'s body diode, or, if lower, the threshold voltage. v_{DIG} is the voltage dropped across SIG's body diode, or, if lower, the threshold voltage.

An alternative version of Charge-supply mode is available in the form shown in FIG. 6 in where there is energizing and draining both into the series connection of battery and output. In this mode both output and battery receives power 100% of the time, speeding up the battery charging process. If the output is selected to be 1.8V, a positive voltage cannot be reliably established across the inductor, if the battery is kept out of deep discharge (v_{B}>3V), which should be preferred [13, 14].

### Input-Supplied Mode

Input-supplied mode happens when the battery is fully charged, and the input only needs to supply the output. The simplified schematic for this mode is shown in FIG. 7.

Therefore, the power stage is reconfigured into a conventional buck converter. S_{XO} is always on, and S_{I} and S_{IG} are switched with non-overlapping energizing and drain signal. The inductor is energized with (v_{IN}-v_{O}) and drained with v_{O}. The ideal energizing duty cycle in this mode where power delivered from input to output can be expressed as:

$${d}_{E I O} = \frac{{v}_{O}}{{v}_{I}} + \frac{{v}_{D I G}}{{v}_{I}} ( \frac{2 {t}_{D T}}{{t}_{C}} ) . \qquad ( 7 )$$

### Other Possible Modes

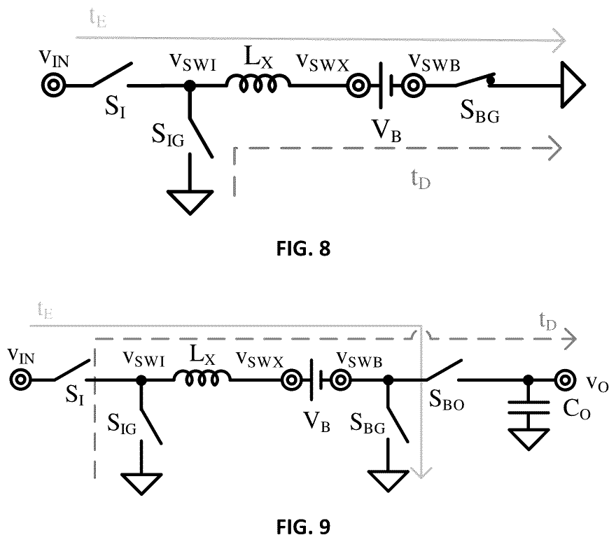

The proposed topology makes many more different operating modes possible that are not selected here due to not fitting the target application. For example, if the output can be disconnected, a mode where input exclusively charges the battery can be arranged, shown in FIG. 8. FIG. 8 illustrates one possible battery charging mode in simplified form.

If we want the battery to be charged faster at the expense of output accuracy, when the input is powering both the load and the battery, we can operate as shown in FIG. 9. FIG. 9 shows a possible fast charge mode in simplified schematic form. In this mode the system would energize into the battery and drain into the battery and output in series. The battery would then be receiving power at all times, accelerating the charging.

This fast operation comes at the expense of maximizing output accuracy. Optimizing for this mode would also be difficult, because it in this mode is much higher than in all other modes. However, the system operating under this mode would still have higher output accuracy than the present state of the art, since the inductor still drains into the output every switching cycle.

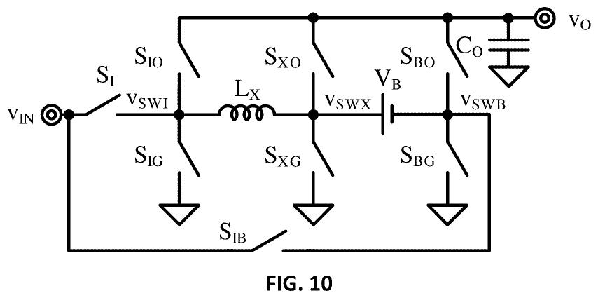

If we want to operate in a boost mode where the output voltage is high, and we want battery assistance in providing for the output, we can modify the topology to include an additional switch S_{IB} as shown in FIG. 10. FIG. 10 is a schematic showing a modified topology to allow battery assistance. With this modified topology various operating modes where we put input vIN and the battery vB in series are possible. In this case the battery is being utilized to assist the system in powering the load.

### CMOS Implementation

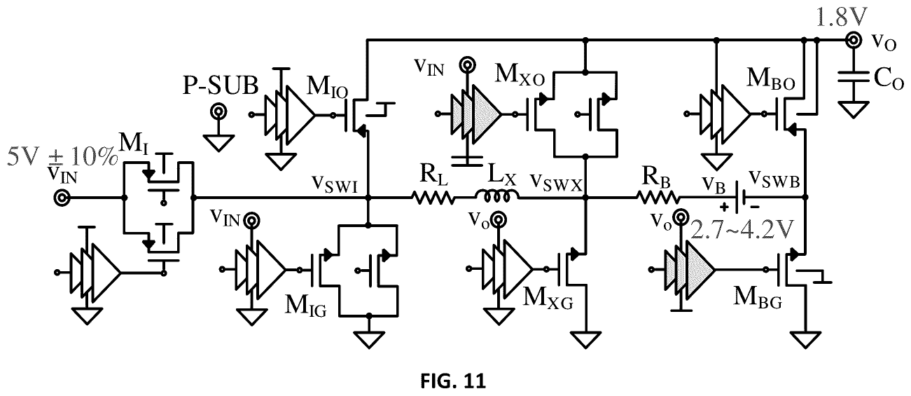

The proposed power stage is implemented with CMOS technology as shown in FIG. 11. FIG. 11 shows a power stage according to principles described herein implemented in CMOS. The target process is TSMC 180 HV BCD Gen2 because of its accessibility and capability to handle higher voltages imposed by the lithium-ion battery. Due to the relative high input voltage of 5V and relative low output voltage of 1.8V of the target application, N-Type devices should be preferred for all switches beside the input switch, due to their superior gate drive compounded with their higher carrier mobility.

However, due to the flexibility of this topology, complex switching node voltages may appear across operating modes, causing severe undesirable leakage or body conduction if not designed carefully. For this reason, M_{XO} is designed to be N-Type while M_{IO} and M_{BO} are designed to be P-Type to block undesirable leakage during operation, the mechanic of which is detailed in the following sections.

### Blocking Diodes

It is possible to block the conduction of switches or body diodes either due to node voltages or inductor current when it is not intended. Undesirable conductions are caused by two types of action: body diode action and implicit diode action.

Implicit Diodes: When an NMOS gate is grounded or a PMOS gate is pulled up to v_{DD}, if its source is pulled below ground or, for a PMOS, above v_{DD} by v_{TH}, the MOSFET turns on. This is the implicit diode action of a regular MOSFET [15], even if it is not diode connected, and the body diodes are blocked.

During the dead-time of Charge-supply mode and Input-supplied mode, the switching input node v_{SWI} is droppeds below ground to −v_{TH} due to the inductor current, turning on any NMOS connected to the node even if their gates are grounded to shut it off. Since we want the dead-time current to flow to the output, we want M_{IG} to undergo implicit diode action to provide inductor current during dead-time, but not M_{IO}. Because turning on M_{IO} would take current away from the output. So M_{IO} is designed to be P-type.

For similar reasons M_{BO} is designed to be P-type to accommodate the reversed inductor current in the battery-supplied mode. M_{XO} remains N-type since it's easy to switch its gate negative supply to a negative voltage when it is not being used, as discussed in Section [0081].

Body Diodes: To block undesirable body conduction, care should be taken when designing body connections of MOSFET switches. Referring to FIG. 11, M_{IG}, M_{XG}, and M_{XO} are regular 5V devices sharing their body, which is connected to ground. These NMOS switches are on the left side/positive side of the battery, where the only voltage below ground is witnessed during dead-time, when appropriate body conduction is accepted and intended.

The P-Type M_{I} and M_{IO} should not conduct dead-time current, so their bodies can be connected to the side with highest potential to block body conduction. However, depending on the operating mode, the high voltage may appear at either side of the MOSFET.

For example, in Charge-supply mode and Input-supplied mode's energizing cycles, v_{SWI} is the higher potential at 5V of v_{IN}, but during draining v_{O} is the higher potential at 1.8V compared to v_{SWI}'s 0V. Connecting the bodies of M_{I} and M_{IO} to v_{IN} is not possible either since input can be absent. Therefore M_{I} and M_{IO}'s bodies need to be connected to a special block, a v_{MAX} selector block, that dynamically selects the highest voltage in the system. The block is detailed in Section [0081].

Still referring to FIG. 11, on the right side of the battery on the v_{SWB} node, we can observe negative voltages up to −v_{B} when v_{SWX} is grounded, which can be even more severe during dead-time. This is caused by the floating battery topology where there's no switch in front of the battery to isolate it from the rest of the system. The P-Type M_{BO}'s body can be connected up to the output node, but M_{BG}'s body poses a problem, since connecting it to the shared body at ground cannot block body conduction when v_{SWB}'s voltage drops to −v_{B}. Therefore, we need to connect M_{BG}'s body, alongside its gate driver's negative supply, to a minimum voltage selector node v_{MIN}, which dynamically selects the lowest voltage in the system. This way undesirable body and channel connection is therefore prevented.

There are reasons for not connecting the shared the body to the v_{MIN} block. First, it creates severe body effect for all NMOS in the system, creating high power loss. Second, the shared body would have a high capacitance, which would be continually charged and discharged by the dynamic v_{MIN} voltage, also creating high power loss. Therefore, isolating the its body can be helpful, which can be done in modern processes including TSMC's BCD Gen 2, by surrounding it with an epitaxially grown N type wall.

S_{BO} can be a NMOS too if we isolate its body and connect it to v_{MIN}. But the increased gate swing from v_{IN} to (v_{IN}+|v_{MIN}|) increases gate charge loss, resulting in a higher overall loss compared to PMOS, and consequentially S_{BO} as NMOS loses its advantage over PMOS. So, a PMOS is still selected for S_{BO}.

### Dead-Time Conduction

Since we want the dead-time current to go towards the output to not waste power, the body diode of P-Type S_{BO} must be connected to the output, so that when the inductor current flows from left to right, the dead-time current will flow through S_{BO}'s body diode to the output. For when the inductor current flow from right to left during Battery-supplied mode, no special body connection is needed as S_{IO} is constantly on during the operating mode when that happens, so the dead-time current will flow through its channel just like normal operating currents.

### Minimum/Maximum Voltages

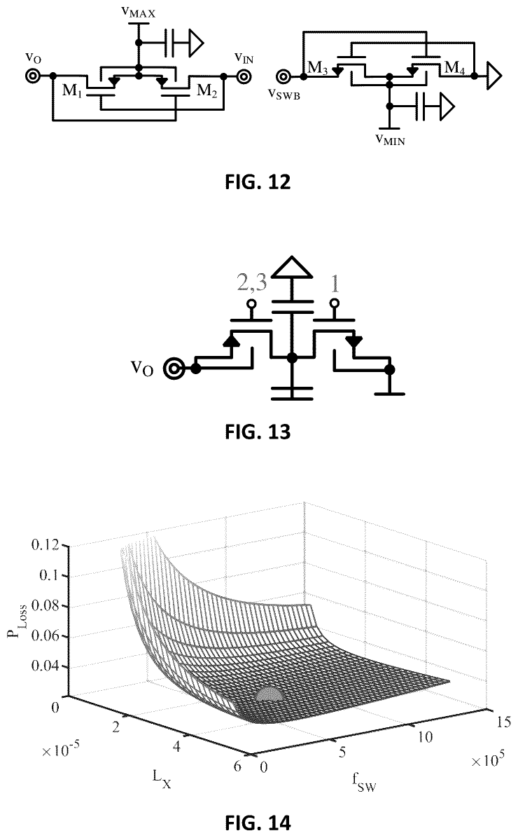

The maximum and minimum voltage selectors are shown above in FIG. 12. The maximum voltage selector selects between the two high voltages in the system: v_{O} and v_{IN}. The minimum voltage selector selects between the two lowest potentials in the system: v_{SWB} and ground. The selector node voltage v_{MAX} and v_{MIN} can dynamically track the more extreme voltage, whether it's a stable or a switching voltage. The use for these blocks are discussed in previous sections. Note that vMAX is not actually selecting the two highest voltages in the system, which would be v_{IN} and v_{SWX}, the reason being that v_{SWX} is only connected to N-Type devices, so high voltages at v_{SWX} would not cause undesirable conduction.

When the voltages being selected from are close to each other within one VTH, which can happen for the v_{MIN} block, neither MOSFET in the selector has a solid gate drive, which can result in the selector not functioning as intended. This requires the system to be designed to not rely on selector voltages during such transients. Or the system could be designed to function normally, even when v_{MIN} selector voltage is stuck a v_{TH} from the other node that is being selected. For example v_{MIN} cannot react to v_{SWI} dropping to −v_{TH} even if we design a v_{MIN} block connected to it, so a N-Type M_{IO}'s undesirable implicit diode conduction during dead-time cannot be prevented without a static negative rail. For this reason M_{IO} is selected as P-Type instead.

A negative rail can also effectively block undesirable implicit and body diode conduction. But a dynamic v_{MIN} selector is preferred, both for the improved performance from not having body effect when M_{BG} is on, and for the lowered silicon area requirement from not needing a big capacitor, which would be required for charging the gates of the big power switches.

The negative supply of the gate drivers of M_{XO} can be switched between v_{O} and v_{MIN} with the switches shown in FIG. 13. FIG. 13 is a schematic of a negative gate-driver supply M_{XO}. During Charge-supply mode and Input-supplied mode, the voltage at the source of M_{XO} never drops below v_{O}, therefore driving the gate driver's negative supply with v_{O} instead of GND is sufficient and saves gate charging energy. During battery-supplied mode where we need a negative voltage to prevent dead-time conduction of M_{XO}'s implicit diode action, we can connect it to v_{MIN}, which would select v_{SWB} when v_{SWB} is being dropped to a very low negative voltage by the dead-time current.

### Sizing and Switching Frequency Design

This section discusses the process of designing the system parameters: switch sizes, switching frequency, and inductor size.

Switch sizing: When sizing the MOSFET switches in the system, we need to balance the two losses that it contributes to, There's ohmic loss PRM that scales inversely with transistor width[16]:

$${P}_{R M} = [ {i}_{O}^{2} + {( \frac{0 \text{.5} Δ {i}_{L}}{\sqrt{3}} )}^{2} ] \frac{L}{W} \frac{{d}_{E / D}}{{K}_{N / P} ( {v}_{G S / S G} - \vert {v}_{T H} \vert )} , \qquad ( 8 )$$

where K_{N/P} is the transconductance parameter L is the length of the transistor, and W is the width of the transistor. There's also gate charge loss PGC that scales linearly with transistor width:

$${P}_{G C} = {f}_{S W} {V}_{G} {C}_{G} , \qquad ( 9 )$$

where f_{SW} is the switching frequency, VG is the voltage swing of the gate drive, CG is the gate capacitance, which scales linearly with transistor width.

We can arrive at the optimal width where we have the least loss by taking a derivative of P_{RM}+P_{GC} with respect to width.

Inductor sizing and switching frequency: Similar to MOSFET switch sizing, there's an optimal size for the inductor, determined by the inductor ohmic loss P_{RL} which scales linearly with inductor size with an extra AC component from skin effect [17-19], and core loss which scales inversely with inductor size [20, 21].

As shown in (8) and (9), optimal MOSFET sizing depends on both the inductor sizing, which determines Δi_{L}, and f_{SW} selection, and inductor sizing depends on switching frequency selection. Therefore we need to optimize these components together and find the stationary point of the PLoss function with respect to its two variables, L_{X} and f_{SW}. Every loss and their dependency on L_{X} and f_{SW} is shown in TABLE I. below:

TABLE I
ALL LOSSES IN SYSTEM AND THEIR DEPENDENCY

| Loss | Dependency |
|---|---|
| P_{DT} | f_{SW}L_{X}⁰ |
| P_{GC} | f_{SW}L_{X}⁰ |
| P_{RM(DC)} | f_{SW}⁰L_{X}⁰ |
| P_{RL(DC)} | f_{SW}⁰L_{X} |
| P_{RM(AC)} | f_{SW}⁻²L_{X}⁻² |
| P_{RL(AC)} | f_{SW}⁻²L_{X}⁻¹ |
| P_{Core} | f_{SW}⁻¹L_{X}⁻¹ |
| P_{IV} | f_{SW}⁻¹L_{X}⁻¹ |
| P_{RB} | f_{SW}⁰L_{X}⁰ |

P_{DT} denotes dead-time loss, DC/AC subscripts denote the DC/AC components of a particular loss, PRM denotes MOSFET ohmic loss, P_{RL} denotes inductor equivalent series resistance (ESR) loss, P_{RB} denotes battery ESR loss, and P_{Core} denotes inductor core loss. The total PLoss is the sum of these losses. The minimum PLoss point can be visualized in FIG. 14.

Such a plot can be generated for each operating mode. The average optimal L_{X} is found, and system is re-optimized with the average L_{X} to find the optimal f_{SW} for each operating mode. Each operating mode is then simulated under its own optimal switching frequency.

The proposed CMOS power stage is simulated in LTspice to verify its operation. MOSFET models with value extracted from TSMC documentation and simulation are used to construct the models used in LTspice. The controller is not yet implemented, so the gate driver stacks are driven by ideal voltage sources with manually inputted on times. The switching frequencies are set to the optimal value for each mode, and a current source at the output is used to sink a current of 250 mA, which is half the entire operating range. The simulated min/max selector output v_{MIN} and v_{MAX}, inductor current i_{L}, and output voltage v_{O} are plotted to show system operation. Duty cycle is calculated using (5)-(7) with the optimal f_{SW} derived in section [0086], with a dead-time of 5 ns.

### Battery-Supplied Mode

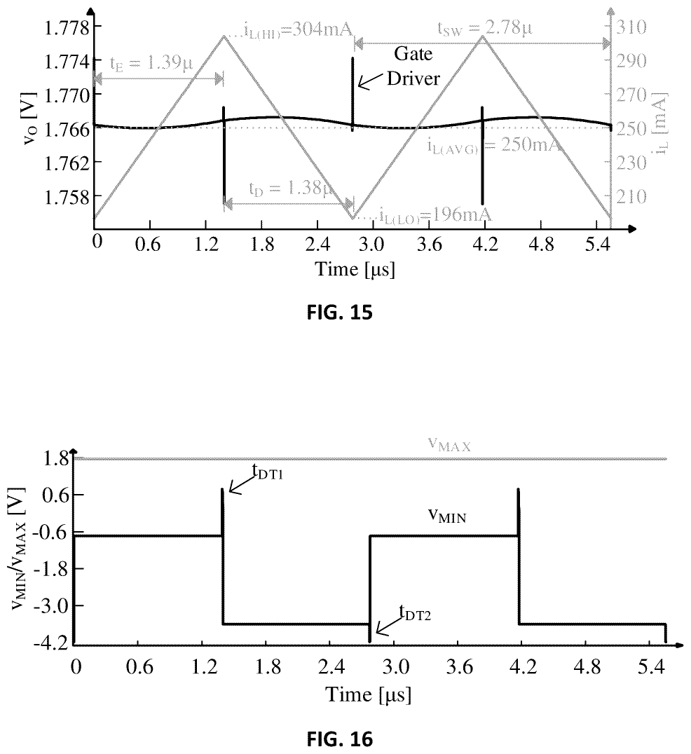

The simulation plots of this mode are shown below in FIG. 15. FIG. 15 shows battery-supplied mode simulations of i_{L} and v_{O}. The spikes on the v_{O} plot are the result of gate drivers taking energy from v_{O} for the switches driven directly by it.

The v_{MIN} and v_{MAX} voltages are shown in FIG. 16. Error! Reference source not found. FIG. 16 shows battery supplied mode simulation of v_{MIN} and v_{MAX}. The v_{MAX} voltage is a steady v_{O}, because it's not being used by any switching MOSFETs. v_{MIN} switches between −vB and −vTH during energizing and draining time, as expected. The v_{MIN} voltage spikes twice during the two dead-time in this mode.

During the dead-time after the energizing period, t_{DTI}, both switches in the v_{MIN} selector are off, because the difference between v_{SWB} and GND is smaller than VTH. The v_{MIN} voltage spikes up since M_{BG} is turning off, charging the v_{MIN} node. M_{BG} therefore conducts dead-time current instead of M_{XG}. During the dead-time after the draining period, t_{DT2}, v_{SWB}'s voltage is dragged down by the inductor current, and v_{MIN}'s voltage follows, creating a spike.

The power loss in this mode is 19.52 milli watts, with 17.1% being PRM, 23.8% being PRL, 24.1% being PRB, 14.1% being PGC, 4.1% being PDT, 16.1% being P_{Core}, and 0.7% of other losses including PIV, PR(AC) etc. The conversion efficiency of this mode is 95.84%, and fractional loss is 4.16%.

### Charge-Supply Mode

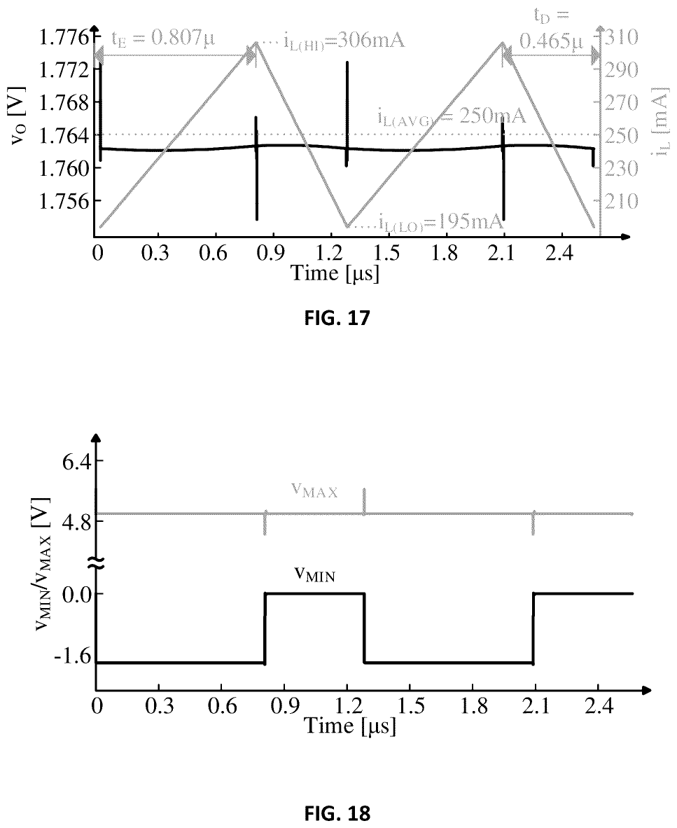

The simulation plots of this mode are shown below in FIG. 17 and FIG. 18. FIG. 17 shows charge-supply mode simulation of I_{L} and V_{O}, and FIG. 18 shows Charge-supply mode simulation v_{MIN} and v_{MAX}. The v_{MAX} is a steady voltage set by v_{IN}, with spikes created by gate drivers' operations. v_{MIN} switches between (v_{O}-v_{B}) and GND during energizing and draining time, as expected.

The power loss in this mode is 27.29 milli watts, with 15.3% being PRM, 17% being PRL, 12.9% being PRB, 15.3% being PGC. 12.6% being PDT, 26.5% being P_{Core}, and 0.4% of other losses including PIV, PR(AC) etc. The conversion efficiency of this mode is 96.63%, and fractional loss is 3.37%.

### Input-Supplied Mode

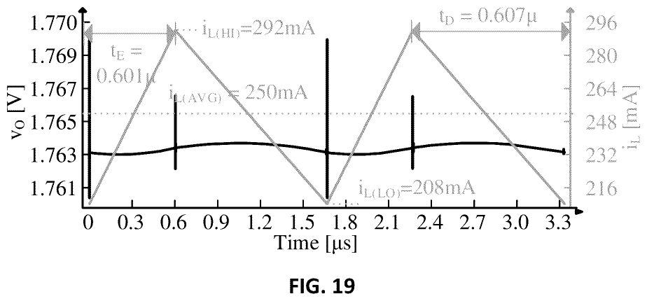

The simulation plot of this mode is shown in FIG. 19. FIG. 19 shows Input-supplied mode simulation i_{L} and v_{O}. v_{MAX} and v_{MIN} are not shown since they are both steady voltages at v_{IN} and (v_{O}-v_{B}) respectively in this mode.

The power loss in this mode is 13.89 milli watts, with 20.4% being PRM, 33.4% being PRL, 0% being PRB, 14.1% being PGC, 9.5% being PDT, 22.3% being P_{Core}, and 0.3% of other losses including PIV, PR(AC) etc. The conversion efficiency of this mode is 98.01%, and fractional loss is 2.99%.

From the simulations, we can see that the systems achieves a conversion efficiency of 95.84%˜98.01%, and a static ripple of less than 0.6 milli volts, which is 0.03% of the output voltage, with an output capacitor of 30 micro Farads, and only one inductor of 23 micro Henries. The low ripple, low power loss combined with the low space consumption of this topology eliminates the tradeoff between them for traditional topologies, as long as the output's current matches the charging profile of the battery.

This system described herein would be useful in applications where a power supply can charge a battery and supply a load at the same time. It is especially advantageous in applications where high efficiency and output accuracy is desired, and strict space constraint is present. Most modern portable electronics all have preferences for such a system. Even though this demo system presented in this report is for 5V input and 1.8V output applications, the fundamental topology shown in FIG. 3 is flexible and can be applied to a wide variety of situations.

This work proposes a new efficient battery-charging voltage regulator topology that mitigates the space/cost vs. accuracy/efficiency tradeoff in the state of the art. The topology arranges switches around the battery and the inductor, creating a configurable switched-inductor power supply. This power stage is able to regulate power between an input, a battery, and an output to power the output continuously with or without the input present. The battery can be charged at the same time as the load is powered, by putting them in series as a flying battery. This allows uninterrupted power output to the load while charging the battery simultaneously, with only one inductor. The main target application is on-the-go battery charging with other batteries, and portable electronics in general. Examples include laptop to phone/tablet charging, power bank to phone/tablet charging, smart watch charging, etc.

In an example embodiment, a battery-charging voltage regulator includes an inductor L_{X}; a battery v_{B} in series with the inductor L_{X}; an output terminal v_{O} selectively electrically connectable to the battery v_{B}; and an input terminal v_{IN} selectively electrically connectable to an input of the inductor L_{X}.

The battery-charging voltage regulator, for example, may be configured with an inductor L_{X}; a battery v_{B} in series with the inductor L_{X}, wherein the inductor is between a first node V_{SWI} and a second node v_{SWX} and the battery is between the second node v_{SWX} and a third node v_{SWB}; an output terminal v_{O} selectively electrically connectable to the first node V_{SWI} via a first output switch S_{IO}, to the second node v_{SWX} via a second output switch S_{XO} and to the third node v_{SWB} via a third output switch S_{BO}; and an input terminal v_{IN} selectively electrically connectable to the first node v_{SWI} via an input switch S₁ between the first node v_{SW1} and the input terminal v_{IN}.

In the battery-charging voltage regulator, the first node v_{SWI} may be electrically connectable to ground via a first ground switch S_{IG}, the second node v_{SWX} may be electrically connectable to ground via a ground switch S_{XG} and the third node v_{SWB} may be connectable to ground via a third ground switch S_{BG}.

In the battery-charging voltage regulator, the inductor L_{X} and the battery v_{B} may be configurable in a battery supply mode, a charge supply mode, and an input-supplied mode.

In the battery-charging voltage regulator, in the battery supply mode, the input switch output switch S_{IO} is closed and the first ground switch S_{IG}, the second output switch S_{XO}, and the third output switch S_{BO} are open.

The charge supply mode includes an energizing duty cycle and a draining duty cycle.

In the energizing duty cycle, the input switch SI and the second output switch SXO may be closed such that the inductor is energized with VIN-VO such that power is delivered to the output.

In the draining duty cycle, the first ground switch SIG and the third output switch SBO may be on such that power is delivered to both the battery VB and the output VO.

In an alternative charge supply mode, the input switch SI and the first ground switch SIG are open and the third output switch SBO is closed such that both the output terminal and the battery receive power from the inductor. In the input-supplied mode, second output switch SXO is on, and first ground switch SIG and the input switch SI are switched with non-overlapping energizing and drain signals, such that the output terminal receives power from the inductor such that the inductor is energized with VIN-VO and drained with VO.

In an aspect, the inductor and the battery may be configurable in a battery charging mode wherein the input switch SI and the first ground switch SIG are switched with non-overlapping energizing and drain signals and the third ground switch SBG is closed, such that the battery always receives power, and output does not receive power.

The inductor and the battery may be configurable in a battery charging mode wherein the input switch SI, the third ground switch SBG are closed in the energizing duty cycle, and the first ground switch SIG, third output switch SBO are closed in the draining duty cycle, such that the battery always receives power, and the output receives power during draining.

The battery charging voltage regulator may include a battery switch SIB between the third node VSWB and the input terminal VIN.

The battery charging voltage regulator may include an output capacitance connected between the output terminal and ground.

In the battery charging voltage regulator, the first output switch SIO, the second output switch SXO, the third output switch SBO, the first ground switch SIG, the second ground switch SXG, third ground switch SBG, and the input switch SI may each comprise metal-oxide semiconductors.

For example, the second output switch SXO may be a N-Type MOSFET; the first output switch SIO may be a P-Type MOSFET; and the third output switch SBO may be a P-Type MOSFET.

In battery supply mode, in a device in which the second ground switch SXG is an N-Type MOSFET, the third ground switch SBG is an N-Type MOSFET, the second ground switch SXG and the third ground switch SBG may be switched with non-overlapping energizing and drain signals, such that the battery supplies output to the output terminal VO.

In an aspect of the battery charging voltage regulator, the input switch SI may be a P-Type MOSFET with a first body connected to a with a first dynamic potential and the first output switch SIO may be a P-Type MOSFET with a second body connected to a side with a second dynamic potential. The first dynamic potential may be the second dynamic potential.

The first ground switch S_{IG}, the second ground switch SXG, and the second output switch S_{XO} may be MOSFET switches sharing a body, which is connected to ground.

The third output switch S_{BO} may be a P-Type body connected to the output terminal VO.

The battery charging voltage regulator may include a minimum voltage selector circuit between the third node VSWB and ground.

The battery charging voltage regulator may include a maximum voltage selector circuit between input terminal VIN and output terminal VO.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions, and arrangement of the exemplary embodiments without departing from the scope of the present disclosure.

While various embodiments of the present invention have been described above, it should be understood that they have been presented by way of example only, and not limitation. It will be apparent to persons skilled in the relevant art that various changes in form and detail can be made therein without departing from the spirit and scope of the present invention. Thus, the breadth and scope of the present invention should not be limited by any of the above-described exemplary embodiments, but should be defined only in accordance with the following claims and their equivalents.

Throughout this application, various publications may have been referenced. The disclosures of these publications in their entireties are hereby incorporated by reference into this application in order to more fully describe the state of the art to which this invention pertains.
[1] G. A. Rincón-Mora, “Switched Inductors,” in Switched Inductor Power IC Design: Springer International Publishing, 2023, pp. 103-166.
[2] E. Babaei and O. Abbasi, “A new topology for bidirectional multi-input multi-output buck direct current-direct current converter,” International Transactions on Electrical Energy Systems, vol. 27, no. 2, p. e2254, 2017-02-01 2017, doi: 10.1002/etep.2254.
[3] M. Dhananjaya, D. Ponuru, T. S. Babu, B. Aljafari, and H. H. Alhelou, “A New Multi-Output DC-DC Converter for Electric Vehicle Application,” IEEE Access, vol. 10, pp. 19072-19082, 2022-01-01 2022, doi: 10.1109/access.2022.3151128.
[4] J.-Y. Kim, B.-S. Lee, S.-H. Lee, J.-H. Ahn, and J.-K. Kim, “Integrated Single Inductor Converter for a DC Grid System Connected With Battery and Load,” IEEE Transactions on Industrial Electronics, vol. 68, no. 12, pp. 12010-12020, 2021/12//2021, doi: 10.1109/TIE.2020.3047062.
[5] H. Shao, X. Li. C.-Y. Tsui, and W.-H. Ki, “A Novel Single-Inductor Dual-Input Dual-Output DC-DC Converter With PWM Control for Solar Energy Harvesting System,” IEEE Transactions on Very Large Scale Integration (VLSI) Systems, vol. 22, no. 8, pp. 1693-1704, 2014/08//2014, doi: 10.1109/TVLSI.2013.2278785.
[6] Y.-H. Lam, W.-H. Ki, C.-F. Tsui, and P. K. T. Mok, “Single-inductor dual-input dual-output switching converter for integrated battery charging and power regulation,” in 2003 IEEE International Symposium on Circuits and Systems (ISCAS), 2003/05//2003, vol. 3, pp. III-III, doi: 10.1109/ISCAS.2003.1205052. [Online]. Available: files/239/1205052.html
[7] J.-H. Jung. Y.-H. Jung, S.-K. Hong, and O.-K. Kwon, “A High Peak Output Power and High Power Conversion Efficiency SIMIMO Converter Using Optimal on-Time Control and Hybrid Zero Current Switching for Energy Harvesting Systems in IoT Applications,” IEEE Transactions on Power Electronics, vol. 35, no. 8, pp. 8261-8275. 2020/08//2020, doi: 10.1109/TPEL.2019.2963513.
[8] P.-C. Huang and T.-H. Kuo, “A Reconfigurable and Extendable Single-Inductor Single-Path Three-Switch Converter for Indoor Photovoltaic Energy Harvesting,” IEEE Journal of Solid-State Circuits, vol. 55, no. 7, pp. 1998-2008, 2020/07//2020, doi: 10.1109/JSSC.2020.2987722.
[9] D. El-Damak and A. P. Chandrakasan, “A 10 nW-1 μW Power Management IC With Integrated Battery Management and Self-Startup for Energy Harvesting Applications,” IEEE Journal of Solid-State Circuits, vol. 51, no. 4, pp. 943-954, 2016/04//2016, doi: 10.1109/JSSC.2015.2503350.
[10] I. C. Chen, C.-W. Liang, and T.-H. Tsai, “A Single-Inductor Dual-Input Dual-Output DC-DC Converter for Photovoltaic and Piezoelectric Energy Harvesting Systems,” IEEE Transactions on Circuits and Systems II: Express Briefs, vol. 66, no. 10, pp. 1763-1767, 2019/10//2019, doi: 10.1109/TCSII.2019.2921349.
[11] A. Manthiram, “An Outlook on Lithium Ion Battery Technology,” ACS Central Science, vol. 3, no. 10, pp. 1063-1069, 2017-10-25 2017, doi: 10.1021/acscentsci.7b00288.
[12] F. He, “USB Port and power delivery: An overview of USB port interoperabiliy,” in 2015 IEEE Symposium on Product Compliance Engineering (ISPCE), 2015-05-01 2015: IEEE, doi: 10.1109/ispce.2015.7138710.
[13] J. Xiong et al., “Failure detection for over-discharged Li-ion batteries,” in 2012 IEEE International Electric Vehicle Conference, 2012-03-01 2012: IEEE, doi: 10.1109/ievc.2012.6183238.
[14] R. Guo, L. Lu, M. Ouyang, and X. Feng, “Mechanism of the entire overdischarge process and overdischarge-induced internal short circuit in lithium-ion batteries,” Scientific Reports, vol. 6, no. 1, p. 30248, 2016-09-01 2016, doi: 10.1038/srep30248.
[15] G. A. Rincón-Mora, “Field-Effect Transistors,” in Switched Inductor Power IC Design: Springer International Publishing, 2023, pp. 45-102.
[16] G. A. Rincón-Mora, “Power Losses,” in Switched Inductor Power IC Design: Springer International Publishing, 2023, pp. 167-240.
[17] H. A. Wheeler, “Formulas for the Skin Effect,” Proceedings of the IRE, vol. 30, no. 9, pp. 412-424, 1942-09-01 1942, doi: 10.1109/jrproc.1942.232015.
[18] J. D. Cockcroft, “Skin effect in rectangular conductors at high frequencies,” Proceedings of the Royal Society of London. Series A, Containing Papers of a Mathematical and Physical Character, vol. 122, no. 790, pp. 533-542, 1929-02-01 1929, doi: 10.1098/rspa.1929.0038.
[19] G. Antonini, A. Orlandi, and C. R. Paul, “Internal impedance of conductors of rectangular cross section,” IEEE Transactions on Microwave Theory and Techniques, vol. 47, no. 7, pp. 979-985, 1999-07-01 1999, doi: 10.1109/22.775429.
[20] K. Venkatachalam, C. R. Sullivan, T. Abdallah, and H. Tacca, “Accurate prediction of ferrite core loss with nonsinusoidal waveforms using only Steinmetz parameters,” in 2002 IEEE Workshop on Computers in Power Electronics, 2002. Proceedings: IEEE, doi: 10.1109/cipe.2002.1196712.
[21] K. Gorecki and K. Detka, “Analysis of influence of losses in the core of the inductor on parameters of the buck converter,” in 2018 Baltic URSI Symposium (URSI), 2018-05-01 2018: IEEE, doi: 10.23919/ursi.2018.8406725.

What is claimed is:

1. A battery-charging voltage regulator, comprising
an inductor L_{X};
a battery V_{B} in series with the inductor L_{X};
an output terminal V_{O} selectively electrically connectable to the battery V_{B}; and
an input terminal V_{IN} selectively electrically connectable to an input of the inductor L_{X}.

2. A battery-charging voltage regulator, comprising:
an inductor L_{X};
a battery V_{B} in series with the inductor L_{X}, wherein the inductor is between a first node V_{SWI} and a second node V_{SWX} and the battery is between the second node V_{SWX} and a third node V_{SWB};
an output terminal V_{O} selectively electrically connectable to the first node V_{SWI} via a first output switch S_{IO}, to the second node V_{SWX} via a second output switch S_{XO} and to the third node V_{SWB} via a third output switch S_{BO}; and
an input terminal V_{IN} selectively electrically connectable to the first node V_{SWI} via an input switch S₁ between the first node V_{SWI} and the input terminal V_{IN}.

3. The battery-charging voltage regulator of claim 2, wherein the first node V_{SWI} is electrically connectable to ground via a first ground switch S_{IG}, the second node V_{SWX} is electrically connectable to ground via a ground switch S_{XG} and the third node V_{SWB} is connectable to ground via a third ground switch S_{BG}.

4. The battery-charging voltage regulator of claim 3, wherein the inductor L_{X} and the battery V_{B} are configurable in a battery supply mode, a charge supply mode, and an input-supplied mode.

5. The battery-charging voltage regulator of claim 4, wherein in the battery supply mode, the input switch output switch S_{IO} is closed and the first ground switch S_{IG}, the first input switch St, the second output switch S_{XO}, and the third output switch S_{BO} are open, wherein the second ground switch S_{XG}, and the third ground switch S_{BG} are switched.

6. The battery-charging voltage regulator of claim 4, wherein the charge supply mode comprises an energizing duty cycle and a draining duty cycle.

7. The battery-charging voltage regulator of claim 6, wherein, in the energizing duty cycle, the input switch S_{I}, second output switch S_{XO} are closed such that the inductor is energized with V_{IN}-V_{O}.

8. The battery-charging voltage regulator of claim 7, wherein power is delivered to the output.

9. The battery-charging voltage regulator of claim 6, wherein, in the draining duty cycle, the first ground switch S_{IG} and the third output switch S_{BO} are on.

10. The battery-charging voltage regulator of claim 9, wherein power is delivered to both the battery V_{B} and the output V_{O}.

11. The battery-charging voltage regulator of claim 4, wherein, in an alternative charge supply mode, the input switch S_{I} and first ground switch S_{IG} are switched and the third output switch S_{BO} is closed such that both the output terminal and the battery receive power from the inductor.

12. The battery-charging voltage regulator of claim 4, wherein, in the input-supplied mode, second output switch S_{XO} is on, and first ground switch S_{IG} and the input switch S_{I} are switched with non-overlapping energizing and drain signals, such that the output terminal receives power from the inductor.

13. The battery-charging voltage regulator of claim 11, wherein the inductor is energized with V_{IN}-V_{O} and drained with V_{O}.

14. The battery-charging voltage regulator of claim 3, wherein the inductor and the battery are configurable in a battery charging mode wherein the input switch S_{I} and the first ground switch S_{IG} are switched with non-overlapping energizing and drain signals and the third ground switch S_{BG} is closed, such that the battery always receives power, and output does not receive power.

15. The battery-charging voltage regulator of claim 3, wherein the inductor and the battery are configurable in a battery charging mode wherein the input switch S_{I}, the third ground switch S_{BG} are closed in the energizing duty cycle, and the first ground switch S_{IG}, third output switch S_{BO} are closed in the draining duty cycle, such that the battery always receives power, and the output receives power during draining.

16. The battery charging voltage regulator of claim 3, further comprising a battery switch SIB between the third node V_{SWB} and the input terminal V_{IN}.

17. The battery charging voltage regulator of claim 3, further comprising an output capacitance connected between the output terminal and ground.

18. The battery charging voltage regulator of claim 3, wherein the first output switch S_{IO}, the second output switch S_{XO}, the third output switch S_{BO}, the first ground switch S_{IG}, the second ground switch S_{XG}, third ground switch S_{BG}, and the input switch S_{I} are each comprise metal-oxide semiconductors.

19. The battery charging voltage regulator of claim 18, wherein the second output switch S_{XO} comprises a N-Type MOSFET; the first output switch S_{IO} comprises a P-Type MOSFET; and the third output switch S_{BO} comprises a P-Type MOSFET.

20. The battery-charging voltage regulator of claim 19, wherein in battery supply mode, the second ground switch S_{XG} comprises an N-Type MOSFET, the third ground switch S_{BG} comprises an N-Type MOSFET, wherein the second ground switch S_{XG} and the third ground switch S_{BG} are switched with non-overlapping energizing and drain signals, such that the battery supplies output to the output terminal V_{O}.

21. The battery charging voltage regulator of claim 19, wherein the input switch S is a P-Type MOSFET with a first body connected to a first dynamic potential and the first output switch S_{IO} is a P-Type MOSFET with a second body connected to a second dynamic potential, wherein the third ground switch S_{BG} is a N-Type MOSFET with a third body connected to a third dynamic potential.

22. The battery charging voltage regulator of claim 21, wherein the first dynamic potential is the second dynamic potential.

23. The battery charging voltage regulator of claim 18, wherein the first ground switch S_{IG}, the second ground switch S_{XG}, and the second output switch S_{XO} are MOSFET switches sharing a body connected to ground.

24. The battery charging voltage regulator of claim 18, wherein the third output switch S_{BO} comprises a P-Type body connected to the output terminal V_{O}.

25. The battery charging voltage regulator of claim 18, further comprising a minimum voltage selector circuit between the third node V_{SWB} and ground.

26. The battery charging voltage regulator of claim 18, further comprising a maximum voltage selector circuit between input terminal V_{IN} and output terminal V_{O}.
